(19) United States
(12) Patent Application Publication
(10) Pub. No.: US 2023/0324634 A1
(43) Pub. Date: Oct. 12, 2023

(54) MINIATURE OPTOELECTRONIC SIGNAL CONVERSION AND TRANSMISSION DEVICE

(71) Applicant: NIEN-YI INDUSTRIAL CORPORATION, Taipei City (TW)

(72) Inventors: Chi-Wei Lo, Taipei City (TW); Jing-Qing Chan, Taipei City (TW); Cheng-Hsin Kuo, Taipei City (TW); Guan-Shiou Chen, Taipei City (TW)

(21) Appl. No.: 17/717,136

(22) Filed: Apr. 11, 2022

(51) Int. Cl. G02B 6/42

(52) U.S. Cl. CPC G02B 6/4246

(57) ABSTRACT

A miniature optoelectronic signal conversion and transmission device includes an optoelectronic signal module and an optical-fiber connector combined together. The optoelectronic signal module includes a silicon substrate that is electrically connected with a driver chip and an optoelectronic signal processor board arranged in a stacked package. The silicon substrate includes light-transmitting and light-receiving elements. Optical fibers provided in the optical-fiber connector have a signal receiving/transmitting terminal forming a refraction surface corresponding to and spaced from the light-transmitting and light-receiving elements. When an optical signal is transmitted through the optical fibers to the refraction surface, the optical signal is redirected for transmitting toward the light-transmitting and light-receiving elements. The silicon substrate is structured as a conducting body, so that the optoelectronic signal module can be set in electrical connection with the driver chip and the optoelectronic signal processor board in a stacked package.

### TECHNICAL FIELD OF THE INVENTION

The present invention relates generally to a miniature optoelectronic signal conversion and transmission device, and more particularly to one that includes a silicon substrate on which a plurality of light-transmitting and light-receiving elements are provided, such that the silicon substrate (which can be a silicon interposer) serves as a conducting body to allow the silicon substrate, a driver chip, and an optoelectronic signal processor board to be set in electrical connection with each other in a stacked package to form an optoelectronic signal module, and that optical fibers that are provided on an optical-fiber connector are provided with a refraction surface at a terminal and the optical fibers and the light-transmitting and light-receiving elements are arranged to correspond to and space from each other in a vertical direction so that when an optical signal is transmitted through the optical fibers to the refraction surface, the optical signal is caused to change direction for transmission toward the light-transmitting and light-receiving elements thereby achieve an advanced efficacy of miniaturization of the entire structure of the optoelectronic signal conversion and transmission device.

### DESCRIPTION OF THE PRIOR ART

A known optical transceiver, which is disclosed in a previous patent application owned by the inventor that is allocated as Taiwan Patent No. 1521248, includes a connector for connection with a primary circuit board, while a secondary circuit board is connected, by means of wire bonding, to the primary circuit board. An adaptor board is arranged between an optical-fiber connector and the secondary circuit board. Optoelectronic components are mounted on the surface of the adaptor board that faces the optical-fiber connector. An amplifier is electrically connected to the secondary circuit board and is connected, by means of wire bonding, to the optoelectronic components

Such a known optical transceiver (namely the previously mentioned patent owned by the inventor) still suffer numerous drawbacks, which will be described as follows:
(1) The amplifier of the known optical transceiver is electrically connected to and arranged on the primary circuit board, while the optoelectronic components are electrically connected to and arranged on the adaptor board, so that the amplifier and the optoelectronic components are respectively arranged on different objects and are separate from each other. In such an arrangement, the length required for wire bonding between the amplifier and the optoelectronic components must be extended. The greater the wire bonding length, the greater the deterioration of physical signals, and this leads to lowering of the signal quality of the entire optical transceiver.
(2) The amplifier of the known optical transceiver is electrically connected to and arranged on the secondary circuit board, and the secondary circuit board is connected, by means of wire bonding, to the primary circuit board. This arrangement necessarily increases the length of wire bonding or a transmission path between the amplifier and the primary circuit board. Correspondingly, deterioration of physical signals is increased, leading to lowering of the signal quality of the entire optical transceiver.
(3) The amplifier of the known optical transceiver is primarily designed to be arranged on the primary circuit board, and a surface area of the primary circuit board must be increased to correspond thereto in order to accommodate installation of multiple amplifiers. This would make the overall size of the optical transceiver extremely bulky, making it hard to enter the field of miniaturization.

Thus, the primary issue that the present invention aims to resolve is to provide a solution that effectively reduces a distance of wire bonding or transmission path between a signal amplifier and multiple light emission components and a primary circuit board in order to reduce deterioration of physical signals and enhance overall performance of signal transmission.

### SUMMARY OF THE INVENTION

The technical feature of the present invention is that a silicon substrate is provided thereon with and is in electrical connection with a plurality of light-transmitting and light-receiving elements, and the silicon substrate (which can be a silicon interposer) serves as a conducting body to allow the silicon substrate, the driver chip, and the optoelectronic signal processor board to be set in electrical connection with each other in a three-dimensional stacked package to thereby form an optoelectronic signal module; and optical fibers provided in an optical-fiber connector are provided, at an end thereof, with a refraction surface, and the optical fibers and the light-transmitting and light-receiving elements are arranged to respectively correspond to each other and space from each other in a vertical (up-and-down) direction so that when an optical signal is transmitted through the optical fibers to the refraction surfaces, a direction of the optical signal is changed for re-directing and subsequent transmitting toward the light-transmitting and light-receiving elements to achieve an effect of building up a miniaturized structure of the entirety of the optoelectronic electrical signal conversion and transmission device in a three-dimensional stacked package; and also, a distance for wire bonding between the driver chip and the plurality of light-transmitting and light-receiving elements and the optoelectronic signal processor board is effectively reduced to achieve an advantage of reducing deterioration of physical signals and enhancing overall performance of signal transmission.

### BRIEF DESCRIPTION OF THE DRAWINGS

FIG. 1 is a schematic view showing, in an assembled form, a miniature optoelectronic signal conversion and transmission device according to a first embodiment of the present invention.

FIG. 2 is a schematic view showing, in an exploded form, the miniature optoelectronic signal conversion and transmission device according to the first embodiment of the present invention.

FIG. 3 is a schematic view showing, in a sectioned form, the miniature optoelectronic signal conversion and transmission device according to the first embodiment of the present invention.

FIG. 4 is a schematic view showing, in an exploded form, a miniature optoelectronic signal conversion and transmission device according to a second embodiment of the present invention.

FIG. 5 is a schematic view showing, in a sectioned form, the miniature optoelectronic signal conversion and transmission device according to the second embodiment of the present invention.

FIG. 6 is a schematic view showing, in an exploded form, a miniature optoelectronic signal conversion and transmission device according to a third embodiment of the present invention.

FIG. 7 is a schematic view showing, in a sectioned form, the miniature optoelectronic signal conversion and transmission device according to the third embodiment of the present invention.

### DETAILED DESCRIPTION OF THE PREFERRED EMBODIMENT

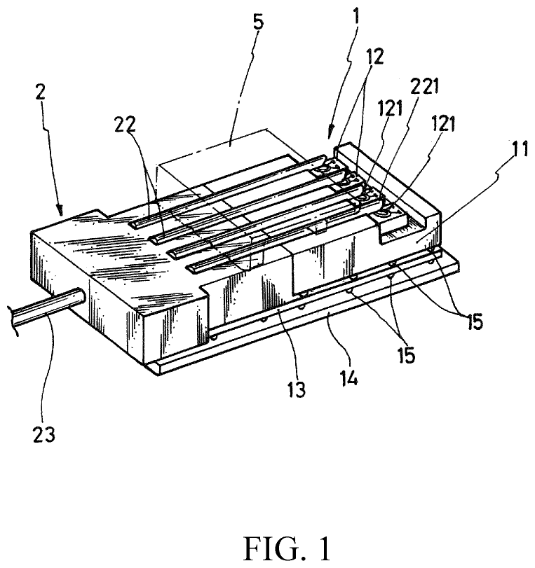

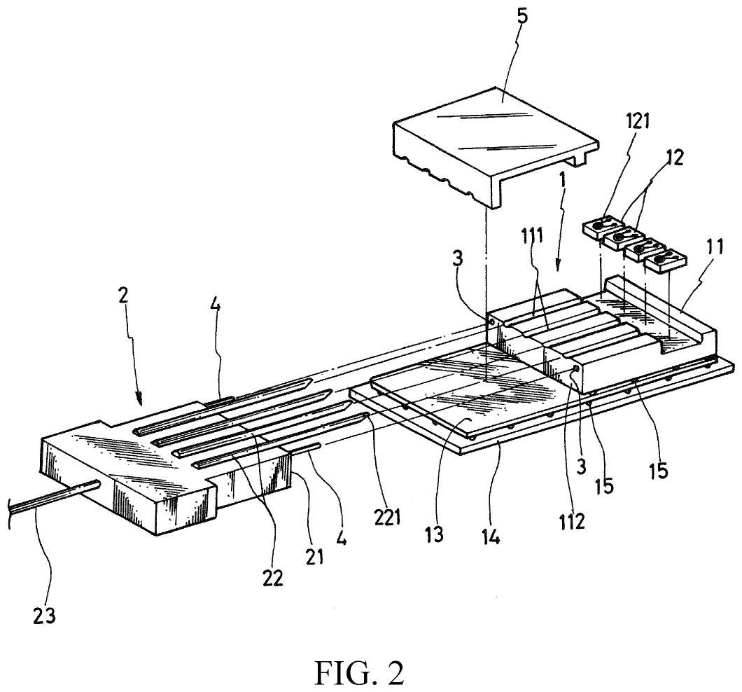

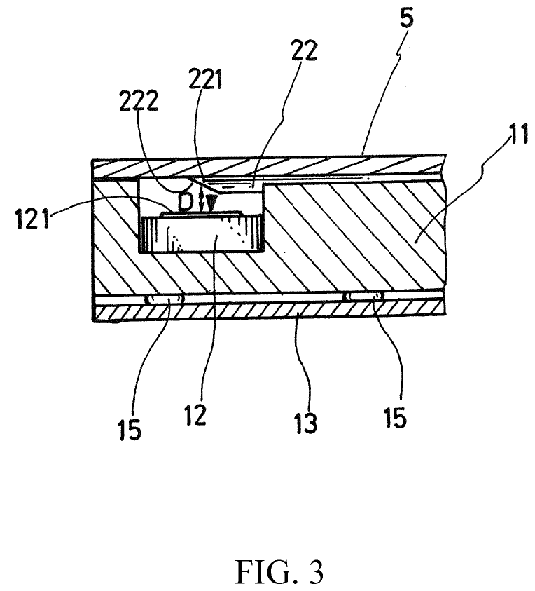

Referring initially to FIGS. 1, 2, and 3, the present invention discloses a miniature optoelectronic signal conversion and transmission device, which comprises, in a first embodiment, an optoelectronic signal module 1 and an optical-fiber connector 2.

The optoelectronic signal module 1 comprises a silicon substrate 11, a plurality of light-transmitting and light-receiving elements 12, at least one driver chip 13, and an optoelectronic signal processor board 14. The silicon substrate 11 can be for example a silicon interposer, which is pre-formed with a plurality of through silicon vias, so that the silicon substrate 11 may serve as a conducting body to allow the silicon substrate 11, the driver chip 13, and the optoelectronic signal processor board 14 to be set in electrical connection with each other in a three-dimensional stacked package. For example, the silicon substrate 11 is connected, by means of the through silicon vias, to conductive bumps 15 (or metallic micro-bumps) pre-formed on an underside to allow the silicon substrate 11, the driver chip 13, and the optoelectronic signal processor board 14 to form three-dimensional stacking in such a way of being in electrical connection with each other through the pre-formed conductive bumps 15. The silicon substrate 11 is provided, on a top surface thereof, with a plurality of light-transmitting and light-receiving elements 12 in electrical connection therewith, so that the plurality of light-transmitting and light-receiving elements 12 are in electrical connection with the driver chip 13 and the optoelectronic signal processor board 14, and the silicon substrate 11 is provided, in the top surface thereof, with a plurality of positioning grooves 111, such that each of the positioning grooves 111 corresponds to a respective one of the light-transmitting and light-receiving elements 12. Further, the silicon substrate 11 is provided, on one of lateral sides thereof, with a first join surface 112, and the first join surface 112 is formed with at least two first positioning parts 3. The light-transmitting and light-receiving elements 12 each include an optical signal transceiver 121, and for example, the optical signal transceiver 121 of the light-transmitting and light-receiving element 12 is arranged to face upward. The driver chip 13 can be for example one of a laser diode (LD) driver chip, a light-emitting diode (LED) driver chip, and a transimpedance amplifier (TIA). The optoelectronic signal processor board 14 is operable for conversion processing of optical signals/electrical signals.

The optical-fiber connector 2 is combinable with the optoelectronic signal module 1, and one of the lateral sides of the optical-fiber connector 2 that faces the first join surface 112 of the silicon substrate 11 is formed with a second join surface 21. The second join surface 21 is provided with at least two second positioning parts 4. The optical-fiber connector 2 is provided with a plurality of optical fibers 22, and each of the optical fibers 22 has an end that is provided with a signal receiving/transmitting terminal 221 extending outside the optical-fiber connector 2. The signal receiving/transmitting terminal 221 is extended into the optoelectronic signal module 1 in such a way as being corresponding to and spaced from a respective one of the light-transmitting and light-receiving elements 12 in a vertical (up-and-down) direction, and the signal receiving/transmitting terminal 221 is formed with a light-deflecting or refraction surface 222. The refraction surface 222 is arranged to correspond to and space from the optical signal transceiver 121 of the respective one of the light-transmitting and light-receiving elements 12 in the vertical (up-and-down) direction by a spacing distance D. For example, the refraction surface 222 of the optical fiber 22 is arranged to face the optical signal transceiver 121, and the refraction surface 222 of the optical fiber 22 corresponds to and is located above the optical signal transceiver 121. Each of the optical fibers 22 has an opposite end that is set in signal connection with a transmission line 23 provided in the optical-fiber connector 2.

The optical fiber 22 is beveled at the signal receiving/transmitting terminal 221 in order to form the refraction surface 222 (which is a beveled surface for light incidence/exiting). A beveling angle of the refraction surface 222 is between 10 degrees and 80 degrees.

The optical-fiber connector 2 and the optoelectronic signal module 1 are combined together such that the second positioning parts 4 (which can be for example in the form of a pillar) of the second join surface 21 of the optical-fiber connector 2 are coupled, through mating engagement, to the first positioning parts 3 (which can be for example in the form of a receiving hole) of the first join surface 112 of the silicon substrate 11, and the optical fibers 22 of the optical-fiber connector 2 are respectively received in the positioning grooves 111 of the silicon substrate 11.

The present invention further comprises a cover 5. The cover 5 is arranged to correspond to and is positioned on tops of the optoelectronic signal module 1 and the optical-fiber connector 2, in order to cover and protect the plurality of optical fibers 22.

The present invention is further explained by taking the first embodiment as an illustrative example, wherein an electrical signal outputted from an external predetermined multimedia device are transmitted through the optoelectronic signal processor board 14 and the driver chip 13 to be converted into an optical signal. The optical signal is projected upward from the optical signal transceivers 121 of the light-transmitting and light-receiving elements 12 and is transmitted to the refraction surfaces 222 of the optical fibers 22 so that the refraction surfaces 222 change a direction of the optical signal to allow the optical signal to enter the optical fibers 22 for subsequent transmission. Reversely, an optical signal received by the optical-fiber connector 2 is transmitted through the optical fibers 22 to the refraction surfaces 222 to change a direction of the optical signal (as being refracted or deflected or redirected downward) for transmission to the optical signal transceivers 121 of the light-transmitting and light-receiving elements 12 to be eventually fed through the driver chip 13 and the optoelectronic signal processor board 14 for converting the optical signal into an electrical signal for outputting to the multimedia device.

Thus, the technical feature of the present invention is that the silicon substrate 11 is provided thereon with and is in electrical connection with the plurality of light-transmitting and light-receiving elements 12, and the silicon substrate 11 (which can be a silicon interposer) serves as a conducting body to allow the silicon substrate 11, the light-transmitting and light-receiving elements 12, the driver chip 13, and the optoelectronic signal processor board 14 to be set in electrical connection with each other in a three-dimensional stacked package to thereby form the optoelectronic signal module 1; and the optical fibers 22 provided on the optical-fiber connector 2 are provided, at an end thereof, with a refraction surface 222, and the optical fibers 22 and the light-transmitting and light-receiving elements 12 are arranged to respectively correspond to each other and space from each other in the vertical (up-and-down) direction so that when an optical signal is transmitted through the optical fibers 22 to the refraction surfaces 222, a direction of the optical signal is changed for re-directing and subsequent transmitting toward the light-transmitting and light-receiving elements 12 to achieve an effect of building up a miniaturized structure of the entirety of the optoelectronic electrical signal conversion and transmission device in a three-dimensional stacked package; and also, a distance for wire bonding between the driver chip 13 and the plurality of light-transmitting and light-receiving elements 12 and the optoelectronic signal processor board 14 is effectively reduced to achieve an advantage of reducing deterioration of physical signals and enhancing overall performance of signal transmission.

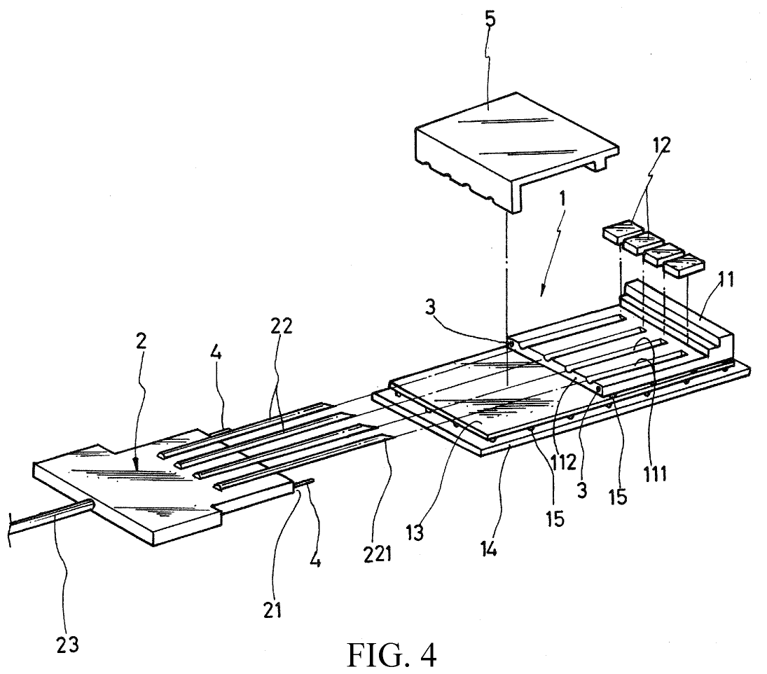

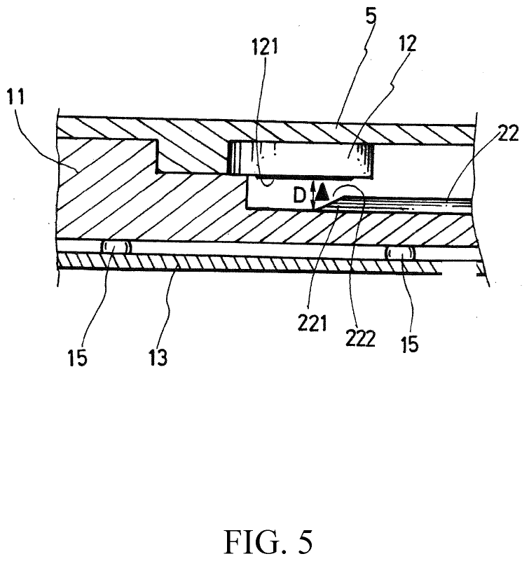

Referring to FIGS. 4 and 5, the present invention discloses a miniature optoelectronic signal conversion and transmission device, which comprises, in a second embodiment, an optoelectronic signal module 1 and an optical-fiber connector 2. The optoelectronic signal module 1 and the optical-fiber connector 2 structured generally the same as those of the first embodiment described previously, yet a difference therebetween is described as follows:

The silicon substrate 11 is provided, on a top surface thereof, with the plurality of light-transmitting and light-receiving elements 12 in electrical connection therewith. The light-transmitting and light-receiving elements 12 have an optical signal transceiver 121. For example, the optical signal transceiver 121 is provided on the light-transmitting and light-receiving element 12 in an arrangement of facing downward. The signal receiving/transmitting terminals 221 of the optical fibers 22 are each provided with a refraction surface 222, and the refraction surface 222 is spaced from a respective one of the optical signal transceivers 121 of the light-transmitting and light-receiving elements 12 by a spacing distance D and is arranged to correspond thereto in the vertical (up-and-down) direction. For example, the refraction surface 222 of the optical fiber 22 is arranged to face the respective optical signal transceiver 121, and the refraction surface 222 of the optical fiber 22 is corresponding to and located below the optical signal transceiver 121.

The present invention is further explained by taking the second embodiment as an illustrative example, wherein an electrical signal outputted from an external predetermined multimedia device are transmitted through the optoelectronic signal processor board 14 and the driver chip 13 to be converted into an optical signal. The optical signal is projected downward from the optical signal transceivers 121 of the light-transmitting and light-receiving elements 12 and is transmitted to the refraction surfaces 222 of the optical fibers 22 so that the refraction surfaces 222 change a direction of the optical signal to allow the optical signal to enter the optical fibers 22 for subsequent transmission. Reversely, an optical signal received by the optical-fiber connector 2 is transmitted through the optical fibers 22 to the refraction surfaces 222 to change a direction of the optical signal (as being refracted or deflected or redirected upward) for transmission to the optical signal transceivers 121 of the light-transmitting and light-receiving elements 12 to be eventually fed through the driver chip 13 and the optoelectronic signal processor board 14 for converting the optical signal into an electrical signal for outputting to the multimedia device.

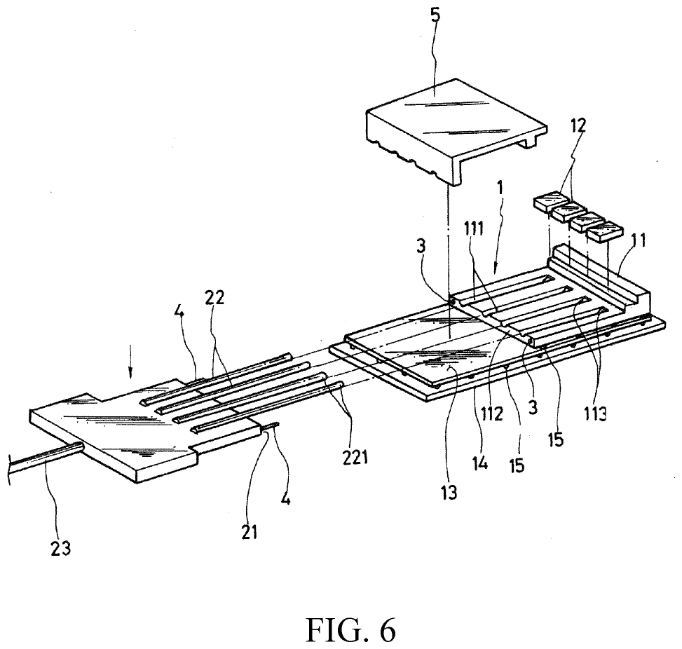

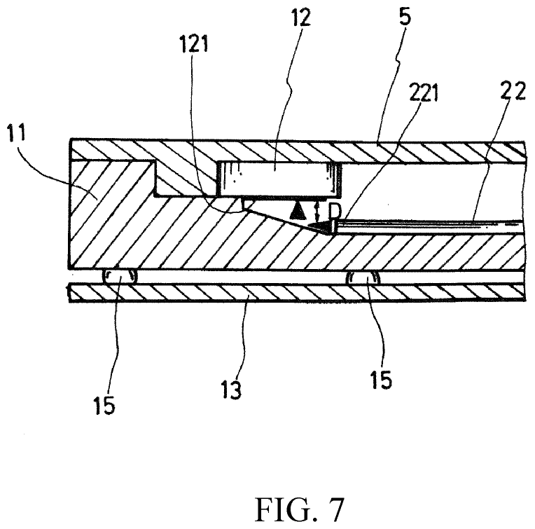

Referring to FIGS. 6 and 7, the present invention discloses a miniature optoelectronic signal conversion and transmission device, which comprises, in a third embodiment, an optoelectronic signal module 1 and an optical-fiber connector 2. The optoelectronic signal module 1 and the optical-fiber connector 2 structured generally the same as those of the first embodiment described previously, yet a difference therebetween is described as follows:

The silicon substrate 11 is provided, on a top surface thereof, with the plurality of light-transmitting and light-receiving elements 12 in electrical connection therewith. The light-transmitting and light-receiving elements 12 have an optical signal transceiver 121. For example, the optical signal transceiver 121 is provided on the light-transmitting and light-receiving element 12 in an arrangement of facing downward. Further, portions of the silicon substrate 11 that are respectively located inside the positioning grooves 111 to correspond to the light-transmitting and light-receiving elements 12 are each formed with a light-deflecting part 113. The light-deflecting part 113 is set at an inclined or beveling angle that is between 10 degrees and 80 degrees. The light-deflecting part 113 is spaced from a respective one of the optical signal transceivers 121 of the light-transmitting and light-receiving elements 12 by a spacing distance D and is arranged to correspond thereto in the vertical (up-and-down) direction. For example, the light-deflecting part 113 of the silicon substrate 11 is arranged to face the respective optical signal transceiver 121, and the light-deflecting part 113 of the silicon substrate 11 is corresponding to and located below the optical signal transceiver 121.

The optical fibers 22 of the optical-fiber connector 2 respectively correspond to and are respectively received in the positioning grooves 111 of the silicon substrate 11, and a cut-off surface (namely a surface for light incidence/exiting) of the signal receiving/transmitting terminal 221 of each of the optical fibers 22 is set in alignment with a respective one of the light-deflecting parts 113 in an axial direction.

The present invention is further explained by taking the third embodiment as an illustrative example, wherein an electrical signal outputted from an external predetermined multimedia device are transmitted through the optoelectronic signal processor board 14 and the driver chip 13 to be converted into an optical signal. The optical signal is projected downward from the optical signal transceivers 121 of the light-transmitting and light-receiving elements 12 and is transmitted to the light-deflecting parts 113 of the silicon substrate 11, so that the light-deflecting parts 113 change a direction of the optical signal to allow the optical signal to enter the signal receiving/transmitting terminal 221 of the optical fibers 22 for subsequent transmission. Reversely, an optical signal received by the optical-fiber connector 2 is transmitted from the signal receiving/transmitting terminals 221 of the optical fibers 22 to the light-deflecting parts 113 to change a direction of the optical signal (as being refracted or deflected or redirected upward) for transmission to the optical signal transceivers 121 of the light-transmitting and light-receiving elements 12 to be eventually fed through the driver chip 13 and the optoelectronic signal processor board 14 for converting the optical signal into an electrical signal for outputting to the multimedia device.

In summary, the technical feature the present invention is essentially such that the silicon substrate 11 (which can be a silicon interposer) is arranged to serve as a conducting body to allow the silicon substrate 11, the light-transmitting and light-receiving elements 12, the driver chip 13, and the optoelectronic signal processor board 14 to be set in electrical connection with in a three-dimensional stacked package to thereby form the optoelectronic signal module 1, and a refraction surface 222 provided at ends of the optical fibers 22 of the optical-fiber connector 2, or a light-deflecting part 113 provided in the silicon substrate 11, is arranged to allow an optical signal transmitted through the optical fibers 22 to change a direction thereof at the refraction surface 222 or the light-deflecting part 113 for subsequent transmitting (re-directing) toward the light-transmitting and light-receiving elements 12, to achieve an effect of building up a miniaturized structure of the entirety of the optoelectronic electrical signal conversion and transmission device in a three-dimensional stacked package, so that, similarly, a distance for wire bonding between the driver chip 13 and the plurality of light-transmitting and light-receiving elements 12 and the optoelectronic signal processor board 14 is effectively reduced to achieve an advantage of reducing deterioration of physical signals and enhancing overall performance of signal transmission.

I claim:

1. A miniature optoelectronic signal conversion and transmission device, comprising:
an optoelectronic signal module, which comprises a silicon substrate, a driver chip, and an optoelectronic signal processor board, which are sequentially stacked and are in electrical connection with each other, wherein the silicon substrate being provided with a plurality of light-transmitting and light-receiving elements in electrical connection therewith, so that the light-transmitting and light-receiving elements are in electrical connection with the driver chip and the optoelectronic signal processor board, the light-transmitting and light-receiving elements including an optical signal transceiver; and
an optical-fiber connector, which is combinable with the optoelectronic signal module, the optical-fiber connector being provided with a plurality of optical fibers, the optical fibers having an end that is formed with an signal receiving/transmitting terminal extending outside of the optical-fiber connector, the signal receiving/transmitting terminal being extended into the optoelectronic signal module to correspond to and space from the light-transmitting and light-receiving elements, the signal receiving/transmitting terminal being provided with a refraction surface, the refraction surface being corresponding to and spaced from the optical signal transceiver by a spacing distance;
wherein a predetermined optical signal is transmittable through the optical fibers to the refraction surface, such that the optical signal is redirected and transmitted toward the optical signal transceiver.

2. The miniature optoelectronic signal conversion and transmission device according to claim 1, wherein the optical signal transceiver of the light-transmitting and light-receiving elements is arranged to face upwards; the refraction surface of the optical fibers faces the optical signal transceiver, and the refraction surface of the optical fibers corresponds to and is located above the optical signal transceiver, so that the predetermined optical signal is transmitted through the optical fibers to the refraction surface, and the optical signal is redirected downwards to transmit toward the optical signal transceiver.

3. The miniature optoelectronic signal conversion and transmission device according to claim 1, wherein the optical signal transceiver of the light-transmitting and light-receiving elements is arranged to face downwards; the refraction surface of the optical fibers faces the optical signal transceiver, and the refraction surface of the optical fibers corresponds to and is located below the optical signal transceiver, so that the predetermined optical signal is transmitted through the optical fibers to the refraction surface, and the optical signal is redirected upwards to transmit toward the optical signal transceiver.

4. The miniature optoelectronic signal conversion and transmission device according to claim 1, wherein the silicon substrate is provided, on a lateral side thereof, with a first join surface, and the first join surface is formed with at least two first positioning parts; and the optical-fiber connector is provided, on a lateral side thereof that faces the first join surface of the silicon substrate, with a second join surface, and the second join surface is formed with at least two second positioning parts, wherein the first positioning parts are respectively corresponding to and in mating engagement with the second positioning parts.

5. The miniature optoelectronic signal conversion and transmission device according to claim 1, further comprising a cover, wherein the cover corresponds to and is positioned on tops of the optoelectronic signal module and the optical-fiber connector to cover the optical fibers.

6. The miniature optoelectronic signal conversion and transmission device according to claim 1, wherein the silicon substrate is formed, in a top surface thereof, with a plurality of positioning grooves, each of the positioning grooves corresponding to one of the light-transmitting and light-receiving elements, and the optical fibers are respectively corresponding to and received in the positioning grooves.

7. A miniature optoelectronic signal conversion and transmission device, comprising:
an optoelectronic signal module, which comprises a silicon substrate, a driver chip, and an optoelectronic signal processor board, which are sequentially stacked and are in electrical connection with each other, wherein the silicon substrate being provided with a plurality of light-transmitting and light-receiving elements in electrical connection therewith, so that the light-transmitting and light-receiving elements are in electrical connection with the driver chip and the optoelectronic signal processor board, the light-transmitting and light-receiving elements including an optical signal transceiver, the silicon substrate being formed, in a top surface thereof, with a plurality of positioning grooves, each of the positioning grooves corresponding to one of the light-transmitting and light-receiving elements, wherein portions of the positioning grooves that correspond to the light-transmitting and light-receiving elements are provided with a light-deflecting part in the form of an inclined surface, a spacing distance being formed between the light-deflecting part the optical signal transceiver, the light-deflecting part being arranged to face the optical signal transceiver and corresponding to and located below the optical signal transceiver; and
an optical-fiber connector, which is combinable with the optoelectronic signal module, the optical-fiber connector being provided with a plurality of optical fibers, the optical fibers having an end that is formed with an signal receiving/transmitting terminal extending outside of the optical-fiber connector, the optical fibers being received in the positioning grooves, a cut-off surface of the signal receiving/transmitting terminal of the optical fibers being in alignment with the light-deflecting part in an axial direction;
wherein a predetermined optical signal is transmittable from the signal receiving/transmitting terminal of the optical fibers to the light-deflecting part, and the optical signal is redirected upwards and transmitted toward the optical signal transceiver.

8. The miniature optoelectronic signal conversion and transmission device according to claim 7, wherein the silicon substrate is provided, on a lateral side thereof, with a first join surface, and the first join surface is formed with at least two first positioning parts; and the optical-fiber connector is provided, on a lateral side thereof that faces the first join surface of the silicon substrate, with a second join surface, and the second join surface is formed with at least two second positioning parts, wherein the first positioning parts are respectively corresponding to and in mating engagement with the second positioning parts.

9. The miniature optoelectronic signal conversion and transmission device according to claim 7, further comprising a cover, wherein the cover corresponds to and is positioned on tops of the optoelectronic signal module and the optical-fiber connector to cover the optical fibers.
